(19) United States
(12) Patent Application Publication
(10) Pub. No.: US 2022/0114585 A1
(43) Pub. Date: Apr. 14, 2022

(54) SYSTEM, METHOD, AND COMPUTER PROGRAM PRODUCT FOR SECURE, REMOTE TRANSACTION AUTHENTICATION AND SETTLEMENT

(71) Applicant: Visa International Service Association, San Francisco, CA (US)

(72) Inventors: Sivanarayana Gaddam, Santa Clara, CA (US); Yogesh Lokhande, Kada Agrahara, Karnataka (IN); Rohit Sinha, Fremont, CA (US)

(21) Appl. No.: 17/277,738

(22) PCT Filed: Sep. 27, 2019
(86) PCT No.: PCT/US19/53370

§ 371 Date: Mar. 19, 2021

Related U.S. Application Data
(60) Provisional application No. 62/737,972, filed on Sep. 28, 2018.

(51) Int. Cl. G06Q 20/38; G06Q 20/40; G06Q 20/06; G06Q 20/20

(52) U.S. Cl. CPC G06Q 20/3823; G06Q 20/3829; G06Q 20/20; G06Q 20/065; G06Q 20/40145

(57) ABSTRACT

Described are a system, method, and computer program product for secure, remote transaction authentication and settlement. The method includes receiving transaction data associated with a transaction to be completed between a merchant and a customer via a point-of-sale (POS) terminal. The method also includes generating a unique identifier for the transaction and sound data encoding the unique identifier. The method further includes storing the unique identifier in association with the transaction data and communicating the sound data to a merchant communication device to cause the sound wave to be produced at the POS terminal for receipt and decoding by a user communication device. The method further includes receiving, from the user communication device, the unique identifier and user payment authorization data. The method further includes corresponding the user payment authorization data with the transaction data and generating a transaction request to an acquirer processor.

### CROSS REFERENCE TO RELATED APPLICATIONS

This application is the United States national phase of International Application No. PCT/US2019/053370 filed Sep. 27, 2019, and claims priority to U.S. Provisional Patent Application No. 62/737,972, filed Sep. 28, 2018, entitled “System, Method, and Computer Program Product for Secure, Remote Transaction Authentication and Settlement,” the entire disclosures of which are hereby incorporated by reference.

### BACKGROUND

### Technical Field

Disclosed embodiments relate generally to transaction authentication and settlement computer networks, and in some non-limiting embodiments or aspects, to a system, method, and computer program product for secured communication via point-to-point encoded signal exchange and remote transaction authentication.

### Technical Considerations

Customer-to-merchant payment, particularly in online marketplaces, can be inconvenient, leading users to abandon their transaction (e.g., “dump” their online shopping cart, exit a store, etc.) prior to completion. There are any number of reasons why users may abandon a transaction prior to completion. For example, a user may discover at checkout that the merchant is requesting them to make an account, sign up for a program, or provide personal information they do not wish to disclose. The user may also find the checkout process to be long and cumbersome, or worse, an electronic checkout process may encounter errors or crash before completion. Also, users may not trust a particular store or website with their credit card information, or the merchant may not accept the payment method of their choosing. Higher rates of transaction completion could be achieved if the underlying issues of security, efficiency, and versatility were addressed, both in brick-and-mortar stores and in e-commerce.

Moreover, from a merchant's perspective, transactions may be subject to fraud. One type of fraud is “friendly fraud,” in which a transaction is completed not by the account holder but by someone (e.g., a relation, a friend) inadvertently using the account holder's payment method, such as a credit card that has been previously linked to a user account. Another type of fraud is “identity fraud,” in which someone intentionally uses an account holder's payment method to complete a transaction. Fraudulent transactions may result in chargebacks, which further increases time and costs in resolution, especially for the defrauded account holder.

There is a need in the art for a convenient and secure method of authenticating a paying user at time of checkout without surrendering or revealing personal information to the merchant or third party authenticators.

### SUMMARY

Accordingly, and generally, provided is an improved system, computer-implemented method, and computer program product for secure, remote transaction authentication and settlement. Preferably, provided is a system, computer-implemented method, and computer program product for receiving transaction data associated with a transaction to be completed between a merchant and a customer via a point-of-sale (POS) terminal. Preferably, provided is a system, computer-implemented method, and computer program product for generating a unique identifier for the transaction and sound data encoding the unique identifier. Preferably, provided is a system, computer-implemented method, and computer program product for storing the unique identifier in association with the transaction data and communicating the sound data to a merchant communication device to cause the sound wave to be produced at the POS terminal for receipt and decoding by a user communication device. Preferably, provided is a system, computer-implemented method, and computer program product for receiving, from the user communication device, the unique identifier and user payment authorization data corresponding the user payment authorization data with the transaction data, and generating a transaction request to an acquirer processor associated with a merchant transaction account.

According to some non-limiting embodiments or aspects, provided is a computer-implemented method for secure, remote transaction authentication and settlement. The method includes receiving, with at least one processor from a merchant communication device, transaction data associated with a transaction to be completed between a merchant and a customer via a point-of-sale (POS) terminal. The transaction data includes at least one of the following: a transaction cost; a transaction description; a transaction time; a merchant identifier; or any combination thereof. The method also includes generating, with at least one processor, (i) a unique identifier for the transaction and (ii) sound data encoding the unique identifier. The sound data is configured to cause an audio output device to produce a sound wave such that, when the sound wave is received by an audio input device, the sound wave is decodable to provide the unique identifier. The method further includes storing, with at least one processor in at least one database, the unique identifier in association with the transaction data. The method further includes communicating, with at least one processor, the sound data to the merchant communication device to cause the sound wave to be produced at the POS terminal for receipt and decoding by a user communication device of the customer. The method further includes receiving, with at least one processor from the user communication device, the unique identifier and user payment authorization data including at least an account identifier associated with a customer transaction account. The method further includes corresponding, with at least one processor and based on the unique identifier received from the user communication device, the user payment authorization data with the transaction data. The method further includes generating, with at least one processor, a transaction request to an acquirer processor associated with a merchant transaction account, the transaction request comprising the user payment authorization data and the transaction data for settlement of payment from the customer transaction account to the merchant transaction account for completion of the transaction.

In some non-limiting embodiments or aspects, the user payment authorization data may be encrypted as received from the user communication device and may be configured for decryption by the acquirer processor. The user payment authorization data may be formatted and encrypted according to a predetermined ruleset input by the acquirer processor. The method may also include receiving, with at least one processor from the merchant communication device, a first sound profile of an environment of the POS terminal. The method may further include receiving, with at least one processor from the user communication device, a second sound profile of an environment of the user communication device. The second sound profile may be recorded during receipt of the sound wave by the user communication device from the POS terminal. The method may further include verifying, with at least one processor, a location of the customer as proximal to the POS terminal based on a comparison of the first sound profile to the second sound profile. A frequency range of the sound wave may be non-overlapping with a frequency range of a portion of the second sound profile associated with the environment of the user communication device.

In some non-limiting embodiments or aspects, the method may also include, in response to receiving the unique identifier from the user communication device, communicating, with at least one processor, at least a portion of the transaction data to the user communication device prior to receiving the user payment authorization data from the user communication device. The method may further include, in response to receiving an acknowledgment from the acquirer processor of the transaction being completed pursuant to the transaction request, communicating, with at least one processor, a transaction confirmation message to the merchant communication device and/or the user communication device.

According to some non-limiting embodiments or aspects, provided is a system for secure, remote transaction authentication and settlement. The system includes at least one server computer including at least one processor. The at least one server computer is programmed and/or configured to receive, from a merchant communication device, transaction data associated with a transaction to be completed between a merchant and a customer via a POS terminal. The transaction data includes at least one of the following: a transaction cost; a transaction description; a transaction time; a merchant identifier; or any combination thereof. The at least one server computer is also programmed and/or configured to generate: (i) a unique identifier for the transaction, and (ii) sound data encoding the unique identifier. The sound data is configured to cause an audio output device to produce a sound wave such that, when the sound wave is received by an audio input device, the sound wave is decodable to provide the unique identifier. The at least one server computer is further programmed and/or configured to store, in at least one database, the unique identifier in association with the transaction data. The at least one server computer is further programmed and/or configured to communicate the sound data to the merchant communication device to cause the sound wave to be produced at the POS terminal for receipt and decoding by a user communication device of the customer. The at least one server computer is further programmed and/or configured to receive, from the user communication device, the unique identifier and user payment authorization data including at least an account identifier associated with a customer transaction account. The at least one server computer is further programmed and/or configured to correspond, based on the unique identifier received from the user communication device, the user payment authorization data with the transaction data. The at least one server computer is further programmed and/or configured to generate a transaction request to an acquirer processor associated with a merchant transaction account. The transaction request includes the user payment authorization data and the transaction data for settlement of payment from the customer transaction account to the merchant transaction account for completion of the transaction.

In some non-limiting embodiments or aspects, the user payment authorization data may be encrypted as received from the user communication device and may be configured for decryption by the acquirer processor. The user payment authorization data may be formatted and encrypted according to a predetermined ruleset input by the acquirer processor. The at least one server computer may be further programmed and/or configured to receive, from the user communication device, a second sound profile of an environment of the user communication device. The second sound profile may be recorded during receipt of the sound wave by the user communication device from the POS terminal. The at least one server computer may be further programmed and/or configured to verify a location of the customer as proximal to the POS terminal based on a comparison of the first sound profile to the second sound profile. A frequency range of the sound wave may be non-overlapping with a frequency range of a portion of the second sound profile associated with the environment of the user communication device.

In some non-limiting embodiments or aspects, the at least one server computer may be further programmed and/or configured to, in response to receiving the unique identifier from the user communication device, communicate at least a portion of the transaction data to the user communication device prior to receiving the user payment authorization data from the user communication device. The at least one server computer may be further programmed and/or configured to, in response to receiving an acknowledgment from the acquirer processor of the transaction being completed pursuant to the transaction request, communicate a transaction confirmation message to the merchant communication device and/or the user communication device.

According to some non-limiting embodiments or aspects, provided is a computer program product for secure, remote transaction authentication and settlement. The computer program product includes at least one non-transitory computer-readable medium including program instructions. The program instructions, when executed by at least one processor, cause the at least one processor to receive, from a merchant communication device, transaction data associated with a transaction to be completed between a merchant and a customer via a point-of-sale (POS) terminal. The transaction data includes at least one of the following: a transaction cost; a transaction description; a transaction time; a merchant identifier; or any combination thereof. The program instructions also cause the at least one processor to generate: (i) a unique identifier for the transaction, and (ii) sound data encoding the unique identifier. The sound data is configured to cause an audio output device to produce a sound wave such that, when the sound wave is received by an audio input device, the sound wave is decodable to provide the unique identifier. The program instructions further cause the at least one processor to store, in at least one database, the unique identifier in association with the transaction data. The program instructions further cause the at least one processor to communicate the sound data to the merchant communication device to cause the sound wave to be produced at the POS terminal for receipt and decoding by a user communication device of the customer. The program instructions further cause the at least one processor to receive, from the user communication device, the unique identifier and user payment authorization data including at least an account identifier associated with a customer transaction account. The program instructions further cause the at least one processor to correspond, based on the unique identifier received from the user communication device, the user payment authorization data with the transaction data. The program instructions further cause the at least one processor to generate a transaction request to an acquirer processor associated with a merchant transaction account. The transaction request includes the user payment authorization data and the transaction data for settlement of payment from the customer transaction account to the merchant transaction account for completion of the transaction.

In some non-limiting embodiments or aspects, the user payment authorization data may be encrypted as received from the user communication device and is configured for decryption by the acquirer processor. The user payment authorization data may be formatted and encrypted according to a predetermined ruleset input by the acquirer processor. The program instructions may further cause the at least one processor to receive, from the user communication device, a second sound profile of an environment of the user communication device. The second sound profile may be recorded during receipt of the sound wave by the user communication device from the POS terminal. The program instructions may further cause the at least one processor to verify a location of the customer as proximal to the POS terminal based on a comparison of the first sound profile to the second sound profile. A frequency range of the sound wave may be non-overlapping with a frequency range of a portion of the second sound profile associated with the environment of the user communication device.

In some non-limiting embodiments or aspects, the program instructions may further cause the at least one processor to, in response to receiving the unique identifier from the user communication device, communicate at least a portion of the transaction data to the user communication device prior to receiving the user payment authorization data from the user communication device. The program instructions may further cause the at least one processor to, in response to receiving an acknowledgment from the acquirer processor of the transaction being completed pursuant to the transaction request, communicate a transaction confirmation message to the merchant communication device and/or the user communication device.

According to some non-limiting embodiments or aspects, provided is a computer-implemented method for secure, remote transaction authentication and settlement. The method includes receiving, with at least one processor from a merchant communication device, transaction data associated with a transaction to be completed between a merchant and a customer via a POS terminal. The transaction data includes at least one of the following: a transaction cost; a transaction description; a transaction time; a merchant identifier; or any combination thereof. The method also includes generating, with at least one processor, (i) a unique identifier for the transaction and (ii) signal data encoding the unique identifier. The signal data is configured to cause an audio output device or visual output device to produce an audio signal or visual signal such that, when the audio signal or the visual signal is received by an audio input device or a visual input device, the audio signal or the visual signal is decodable to provide the unique identifier. The method further includes storing, with at least one processor in at least one database, the unique identifier in association with the transaction data. The method further includes communicating, with at least one processor, the signal data to the merchant communication device to cause the audio signal or the visual signal to be produced at the POS terminal for receipt and decoding by a user communication device of the customer. The method further includes receiving, with at least one processor from the user communication device, the unique identifier and user payment authorization data including at least an account identifier associated with a customer transaction account. The method further includes corresponding, with at least one processor and based on the unique identifier received from the user communication device, the user payment authorization data with the transaction data. The method further includes generating, with at least one processor, a transaction request to an acquirer processor associated with a merchant transaction account, the transaction request comprising the user payment authorization data and the transaction data for settlement of payment from the customer transaction account to the merchant transaction account for completion of the transaction.

Further non-limiting embodiments or aspects will be set forth in the following numbered clauses:

Clause 1: A computer-implemented method for secure, remote transaction authentication and settlement, the method comprising: receiving, with at least one processor from a merchant communication device, transaction data associated with a transaction to be completed between a merchant and a customer via a point-of-sale (POS) terminal, the transaction data comprising at least one of the following: a transaction cost; a transaction description; a transaction time; a merchant identifier; or any combination thereof; generating, with at least one processor, (i) a unique identifier for the transaction and (ii) sound data encoding the unique identifier, the sound data configured to cause an audio output device to produce a sound wave such that, when the sound wave is received by an audio input device, the sound wave is decodable to provide the unique identifier; storing, with at least one processor in at least one database, the unique identifier in association with the transaction data; communicating, with at least one processor, the sound data to the merchant communication device to cause the sound wave to be produced at the POS terminal for receipt and decoding by a user communication device of the customer; receiving, with at least one processor from the user communication device, the unique identifier and user payment authorization data comprising at least an account identifier associated with a customer transaction account; corresponding, with at least one processor and based on the unique identifier received from the user communication device, the user payment authorization data with the transaction data; and generating, with at least one processor, a transaction request to an acquirer processor associated with a merchant transaction account, the transaction request comprising the user payment authorization data and the transaction data for settlement of payment from the customer transaction account to the merchant transaction account for completion of the transaction.

Clause 2: The computer-implemented method of clause 1, wherein the user payment authorization data is encrypted as received from the user communication device and is configured for decryption by the acquirer processor.

Clause 3: The computer-implemented method of clause 1 or 2, wherein the user payment authorization data is formatted and encrypted according to a predetermined ruleset input by the acquirer processor.

Clause 4: The computer-implemented method of any of clauses 1-3, further comprising: receiving, with at least one processor from the merchant communication device, a first sound profile of an environment of the POS terminal; receiving, with at least one processor from the user communication device, a second sound profile of an environment of the user communication device, the second sound profile recorded during receipt of the sound wave by the user communication device from the POS terminal; and verifying, with at least one processor, a location of the customer as proximal to the POS terminal based on a comparison of the first sound profile to the second sound profile.

Clause 5: The computer-implemented method of any of clauses 1-4, wherein a frequency range of the sound wave is non-overlapping with a frequency range of a portion of the second sound profile associated with the environment of the user communication device.

Clause 6: The computer-implemented method of any of clauses 1-5, further comprising, in response to receiving the unique identifier from the user communication device, communicating, with at least one processor, at least a portion of the transaction data to the user communication device prior to receiving the user payment authorization data from the user communication device.

Clause 7: The computer-implemented method of any of clauses 1-6, further comprising, in response to receiving an acknowledgment from the acquirer processor of the transaction being completed pursuant to the transaction request, communicating, with at least one processor, a transaction confirmation message to the merchant communication device and/or the user communication device.

Clause 8: A system for secure, remote transaction authentication and settlement, the system comprising at least one server computer including at least one processor, the at least one server computer programmed and/or configured to: receive, from a merchant communication device, transaction data associated with a transaction to be completed between a merchant and a customer via a point-of-sale (POS) terminal, the transaction data comprising at least one of the following: a transaction cost; a transaction description; a transaction time; a merchant identifier; or any combination thereof; generate (i) a unique identifier for the transaction and (ii) sound data encoding the unique identifier, the sound data configured to cause an audio output device to produce a sound wave such that, when the sound wave is received by an audio input device, the sound wave is decodable to provide the unique identifier; store, in at least one database, the unique identifier in association with the transaction data; communicate the sound data to the merchant communication device to cause the sound wave to be produced at the POS terminal for receipt and decoding by a user communication device of the customer; receive, from the user communication device, the unique identifier and user payment authorization data comprising at least an account identifier associated with a customer transaction account; correspond, based on the unique identifier received from the user communication device, the user payment authorization data with the transaction data; and generate a transaction request to an acquirer processor associated with a merchant transaction account, the transaction request comprising the user payment authorization data and the transaction data for settlement of payment from the customer transaction account to the merchant transaction account for completion of the transaction.

Clause 9: The system of clause 8, wherein the user payment authorization data is encrypted as received from the user communication device and is configured for decryption by the acquirer processor.

Clause 10: The system of clause 8 or 9, wherein the user payment authorization data is formatted and encrypted according to a predetermined ruleset input by the acquirer processor.

Clause 11: The system of any of clauses 8-10, wherein the at least one server computer is further programmed and/or configured to: receive, from the user communication device, a second sound profile of an environment of the user communication device, the second sound profile recorded during receipt of the sound wave by the user communication device from the POS terminal; and verify a location of the customer as proximal to the POS terminal based on a comparison of the first sound profile to the second sound profile.

Clause 12: The system of any of clauses 8-11, wherein a frequency range of the sound wave is non-overlapping with a frequency range of a portion of the second sound profile associated with the environment of the user communication device.

Clause 13: The system of any of clauses 8-12, wherein the at least one server computer is further programmed and/or configured to, in response to receiving the unique identifier from the user communication device, communicate at least a portion of the transaction data to the user communication device prior to receiving the user payment authorization data from the user communication device.

Clause 14: The system of any of clauses 8-13, wherein the at least one server computer is further programmed and/or configured to, in response to receiving an acknowledgment from the acquirer processor of the transaction being completed pursuant to the transaction request, communicate a transaction confirmation message to the merchant communication device and/or the user communication device.

Clause 15: A computer program product for secure, remote transaction authentication and settlement, the computer program product comprising at least one non-transitory computer-readable medium including program instructions that, when executed by at least one processor, cause the at least one processor to: receive, from a merchant communication device, transaction data associated with a transaction to be completed between a merchant and a customer via a point-of-sale (POS) terminal, the transaction data comprising at least one of the following: a transaction cost; a transaction description; a transaction time; a merchant identifier; or any combination thereof; generate (i) a unique identifier for the transaction and (ii) sound data encoding the unique identifier, the sound data configured to cause an audio output device to produce a sound wave such that, when the sound wave is received by an audio input device, the sound wave is decodable to provide the unique identifier; store, in at least one database, the unique identifier in association with the transaction data; communicate the sound data to the merchant communication device to cause the sound wave to be produced at the POS terminal for receipt and decoding by a user communication device of the customer; receive, from the user communication device, the unique identifier and user payment authorization data comprising at least an account identifier associated with a customer transaction account; correspond, based on the unique identifier received from the user communication device, the user payment authorization data with the transaction data; and generate a transaction request to an acquirer processor associated with a merchant transaction account, the transaction request comprising the user payment authorization data and the transaction data for settlement of payment from the customer transaction account to the merchant transaction account for completion of the transaction.

Clause 16: The computer program product of clause 15, wherein the user payment authorization data is encrypted as received from the user communication device and is configured for decryption by the acquirer processor.

Clause 17: The computer program product of clause 15 or 16, wherein the user payment authorization data is formatted and encrypted according to a predetermined ruleset input by the acquirer processor.

Clause 18: The computer program product of any of clauses 15-17, wherein the program instructions further cause the at least one processor to: receive, from the user communication device, a second sound profile of an environment of the user communication device, the second sound profile recorded during receipt of the sound wave by the user communication device from the POS terminal; and verify a location of the customer as proximal to the POS terminal based on a comparison of the first sound profile to the second sound profile.

Clause 19: The computer program product of any of clauses 15-18, wherein a frequency range of the sound wave is non-overlapping with a frequency range of a portion of the second sound profile associated with the environment of the user communication device.

Clause 20: The computer program product of any of clauses 15-19, wherein the program instructions further cause the at least one processor to, in response to receiving the unique identifier from the user communication device, communicate at least a portion of the transaction data to the user communication device prior to receiving the user payment authorization data from the user communication device.

Clause 21: The computer program product of any of clauses 15-20, wherein the program instructions further cause the at least one processor to, in response to receiving an acknowledgment from the acquirer processor of the transaction being completed pursuant to the transaction request, communicate a transaction confirmation message to the merchant communication device and/or the user communication device.

Clause 22: A computer-implemented method for secure, remote transaction authentication and settlement, the method comprising: receiving, with at least one processor from a merchant communication device, transaction data associated with a transaction to be completed between a merchant and a customer via a point-of-sale (POS) terminal, the transaction data comprising at least one of the following: a transaction cost; a transaction description; a transaction time; a merchant identifier; or any combination thereof; generating, with at least one processor, (i) a unique identifier for the transaction and (ii) signal data encoding the unique identifier, the signal data configured to cause an audio output device or visual output device to produce an audio signal or visual signal such that, when the audio signal or the visual signal is received by an audio input device or a visual input device, the audio signal or the visual signal is decodable to provide the unique identifier; storing, with at least one processor in at least one database, the unique identifier in association with the transaction data; communicating, with at least one processor, the signal data to the merchant communication device to cause the audio signal or the visual signal to be produced at the POS terminal for receipt and decoding by a user communication device of the customer; receiving, with at least one processor from the user communication device, the unique identifier and user payment authorization data comprising at least an account identifier associated with a customer transaction account; corresponding, with at least one processor and based on the unique identifier received from the user communication device, the user payment authorization data with the transaction data; and generating, with at least one processor, a transaction request to an acquirer processor associated with a merchant transaction account, the transaction request comprising the user payment authorization data and the transaction data for settlement of payment from the customer transaction account to the merchant transaction account for completion of the transaction.

These and other features and characteristics of non-limiting embodiments, as well as the methods of operation and functions of the related elements of structures and the combination of parts and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular forms of “a,” “an,” and “the” include plural referents unless the context clearly dictates otherwise.

### BRIEF DESCRIPTION OF THE DRAWINGS

Additional advantages are explained in greater detail below with reference to the non-limiting embodiments that are illustrated in the accompanying drawings containing schematics and figures, in which:

FIG. 1 is a schematic diagram of a system and method for secure, remote transaction authentication and settlement according to non-limiting embodiments or aspects;

FIG. 2 is a flow diagram of a system and method for secure, remote transaction authentication and settlement according to non-limiting embodiments or aspects;

FIG. 3 is a process diagram of a system and method for secure, remote transaction authentication and settlement according to non-limiting embodiments or aspects;

FIG. 4 is a process diagram of a system and method for secure, remote transaction authentication and settlement according to non-limiting embodiments or aspects;

FIG. 5 is a process diagram of a system and method for secure, remote transaction authentication and settlement according to non-limiting embodiments or aspects; and

FIG. 6 is a process diagram of a system and method for secure, remote transaction authentication and settlement according to non-limiting embodiments or aspects.

### DETAILED DESCRIPTION

For purposes of the description hereinafter, the terms “upper,” “lower,” “right,” “left,” “vertical,” “horizontal,” “top,” “bottom,” “lateral,” “longitudinal,” and derivatives thereof shall relate to the non-limiting embodiments as the embodiments are oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments. Hence, specific dimensions and other physical characteristics related to the embodiments disclosed herein are not to be considered as limiting. Also, it should be understood that any numerical range recited herein is intended to include all sub-ranges subsumed therein. For example, a range of 1 to 10 is intended to include all sub-ranges between (and including) the recited minimum value of 1 and the recited maximum value of 10, that is, having a minimum value equal to or greater than 1 and a maximum value of equal to or less than 10.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” may refer to one or more entities, such as a bank, that provide accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical transaction instrument, such as a payment card, and/or may be electronic and used for electronic payments. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “acquirer institution” may refer to an entity licensed by the transaction service provider and approved by the transaction service provider to originate transactions using a portable financial device of the transaction service provider. The transactions may include original credit transactions (OCTs) and account funding transactions (AFTs). The acquirer institution may be authorized by the transaction service provider to originate transactions using a portable financial device of the transaction service provider. The acquirer institution may contract with a payment gateway to enable the facilitators to sponsor merchants. An acquirer institution may be a financial institution, such as a bank. The terms “acquirer institution,” “acquirer bank,” and “acquirer system” may also refer to one or more computer systems operated by or on behalf of an acquirer institution, such as a server computer executing one or more software applications.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases, such that the tokens can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies the issuer institution among other issuer institutions.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. The term “point-of-sale system” or “POS system”, as used herein, may refer to one or more computers and/or peripheral devices used by a merchant to engage in payment transactions with customers, including one or more card readers, near-field communication (NFC) receivers, radio-frequency identification (RFID) receivers, and/or other contactless transceivers or receivers, contact-based receivers, payment terminals, computers, servers, input devices, and/or other like devices that can be used to initiate a payment transaction. A POS terminal may be located proximal to a user, such as at a physical store location, or a POS terminal may be remote from the user, such as a server interacting with a user browsing on their personal computer.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the term “payment device” may refer to an electronic payment device, a portable financial device, a portable payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a mobile device executing an electronic wallet application, a personal digital assistant, a security card, an access card, a wireless terminal, and/or a transponder, as examples. The payment device may include a volatile or a non-volatile memory to store information, such as an account identifier or a name of the account holder. The payment device may store account credentials locally on the device, in digital or non-digital representation, or may facilitate accessing account credentials stored in a medium that is accessible by the payment device in a connected network.

As used herein, the term “server” may refer to or include one or more processors or computers, storage devices, or similar computer arrangements that are operated by or facilitate communication and processing for multiple parties in a network environment, such as the internet. In some non-limiting embodiments, communication may be facilitated over one or more public or private network environments and that various other arrangements are possible. Further, multiple computers, e.g., servers, or other computerized devices, e.g., POS devices, directly or indirectly communicating in the network environment may constitute a system, such as a merchant's POS system. Reference to a server or a processor, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

The term “account data,” as used herein, refers to any data concerning one or more accounts for one or more users. Account data may include, for example, one or more account identifiers, user identifiers, transaction histories, balances, credit limits, issuer institution identifiers, and/or the like.

In some non-limiting embodiments or aspects, the described systems and methods improve upon existing systems by providing a secure method of authenticating a paying user at the time of checkout without surrendering or revealing personal information to the merchant or third party authenticators. In this way, payment data privacy may be maintained for both brick-and-mortar store POS terminals and online POS terminals (e.g., electronic marketplaces). Furthermore, non-limiting embodiments reduce instances of both “friendly” fraud (e.g., inadvertent use of someone's payment device) and identity fraud (e.g., intentional use of someone's payment device) by adding an additional layer of authentication. Moreover, by using a payment device holder's mobile device to sample their environment (e.g., record audio, record images, record video, etc.) when completing payment authentication, the environmental sample can be used to verify the location of the payment device holder at the time of payment. The described new systems and methods prevent unauthorized payments, which further prevents often-resulting chargebacks, fraud investigation, account lockdown, digital audits, and/or the like, in addition to reducing the use of computing resources, and, therefore, increasing the speed of the system, resulting from processing such chargebacks, lockdowns, and audits.

At a high level, the present disclosure enhances a checkout transaction experience and performs second factor authentication transparently. The present disclosure improves the checkout experience by addressing common issues in the transaction process, removing need for account registration, reducing time of checkout process, minimizing errors by minimizing checkout codes, reducing exposure of payment information or personal information to merchants, and maximizing available payment methods by allowing various mobile applications to complete a transaction. The present disclosure further eliminates the integration burden on merchants. Moreover, the present disclosure makes use of two important features, FatToken and AuthChain, which are described in further technical detail below, followed by detailed description of the systems and methods.

FatToken

FatToken contains encrypted identity attributes, payment credentials, and authentication policies configured by an issuer. An issuer fetches cipher credentials, including user demographics, billing address, and payment credentials upon user authentication request and encrypts the data against the issuer's public key. The issuer provides a pre-configured list of re-encryption keys using payment gateways, such that only payment gateways can decrypt the cipher credentials. The issuer configures the list of authentication policies, such as dynamic authentication, white listed or black listed merchant category codes, amount limit checks, and proximity/background checks before re-encrypting the cipher credentials against the merchant-associated-gateway's re-encryption key. A computing device binds the cipher credentials, public re-encryption keys, and authenticating policies against the computing device (or an application thereon) to prevent skimming attacks on FatToken. The cipher credentials, public re-encryption keys, and authentication policies may be digitally signed with an issuer's private key or a private key of an authentication mediary system (e.g., one or more servers for provisioning and validating token keys, in part).

AuthChain

AuthChain is a blockchain-based system, where any node can perform authentication and log a transaction on behalf of an issuer. Each node may have a Software Guard Extensions (SGX) enabled processor for the efficient and confidential execution of authentication algorithms. AuthChain contains the following building blocks: blockchain node, FatToken, route, authentication policy checker, and audit (log proof).

For the blockchain node, each issuer provisions the SGX node with the following enclaves: enroll, route, authentication policy checker, and audit. The issuer invokes the enroll enclave by inputting a digital signature, public key, and audit public key. The enroll enclave verifies the public key and the signature. The enroll enclave creates a new audit key pair and returns the audit public key to the issuer. The issuer signs the audit public key and returns it to the enroll enclave. The enroll enclave establishes a secure connection with the audit enclave and shares the issuer-signed audit public key and secret key. For the route enclave, each node in the network inspects the request and routes the request to other nodes if not configured to process FatToken from a particular issuer based on the issuer's public key. The authentication policy checker enclave receives FatToken and metadata (e.g., device attributes, behavioral attributes, etc.) as input, executes authentication policies, invokes the audit enclave for logging, and returns re-encrypted cipher credentials and proof of authentication. The audit enclave receives authentication proof from the authentication policy checker enclave and contacts all other audit enclaves to commit the authentication proof to blockchain.

Workflows

The presently-described system has the following phases: on-boarding, setup, and commerce. On-boarding and setup are explained in the present section in further detail.

For on-boarding, payment gateways and issuers communicate with the authentication mediary system and provision keys using proxy-re-encryption. First, a payment gateway runs a key generation procedure and outputs the payment gateway's public/secret keys (GWₚₖ/GWₛₖ). Next, the payment gateway publishes its public key (GWₚₖ, Sign_{GWsk}(GWₚₖ)) to the authentication mediary system (e.g., one or more servers for provisioning and validating token keys, in part). The authentication mediary system (AMS) validates the gateway public key (GWₚₖ) and stores the public key (AMS_Signₛₖ(GWₚₖ)) by signing using the authentication mediary system's secret key. Next, an issuer contacts the authentication mediary system and fetches all payment gateway public keys (<AMS_Signₛₖ(GWₚₖ₁), AMS_Signₛₖ(GWₚₖ₂), . . . AMS_Signₛₖ(GWₚₖₙ)>) to generate re-encryption keys. Next, an issuer runs a key generation procedure and outputs its issuer public/secret keys (Issuerₚₖ/Issuerₛₖ). Next, an issuer filters the payment gateway public keys and invokes key regeneration for each public key. Next, an issuer runs a key regeneration procedure by inputting payment gateway public key (GWₚₖ) and issuer's secret key (Issuerₛₖ), outputting PK_{Issuer→GW} for each payment gateway. Next, an issuer publishes the re-encrypted keys (<PK_{Issuer→GW1}, PK_{Issuer→GW2}, . . . PK_{Issuer→GWn}>) with the authentication mediary system. The authentication mediary system stores (e.g., persists) re-encryption keys from all issuers.

Issuers participate in the AuthChain by adding the SGX-enabled node to the network, interacting with the enroll enclave to start processing transactions. Issuers follow the following procedure to participate in the AuthChain blockchain network. First, an issuer sets up keys as described in on-boarding, above. Next, an issuer authenticates with the authentication mediary system (AMS) via a digital signature and downloads the blockchain software. The issuer provisions the SGX-enabled node, installing the blockchain software. Next, the issuer adds the node to the AuthChain blockchain network. The issuer sends certificate Issuerₚₖ and AMS_Signₛₖ(Issuerₚₖ) to enroll the node for processing transactions. The issuer validates the certificate and generates an audit key pair (Auditₚₖ/Auditₛₖ). Next, the issuer validates the audit public key by verifying the signature. Issuer signs the audit public key after validating it and sends the audit public key to the enroll enclave. The enroll enclave shares audit keys with the audit enclave and finishes the enrollment of the issuer node. Now, the issuer node is ready to execute authentication policies.

Issuers may integrate their mobile applications with a mobile device software development kit (SDK) to help users provision FatToken, link with other partner applications (e.g., social media applications, electronic marketplaces, etc.), and transact with merchants. A mobile device SDK may offer the following functionalities: provision, application links, and commerce. Provision allows users to provision FatToken and store the token in local memory. Application links allows users to choose a list of mobile applications for choice of checkout. Commerce allows users to view a shopping cart and confirm/deny checkout.

Partners (e.g., social media providers, electronic marketplaces, etc.) may integrate their mobile applications with a mobile device SDK to help customers checkout efficiently. A mobile device SDK may offer the following functionalities: application links and commerce. Application links enable users to configure their default provider or select a provider during checkout. Commerce allows users to view their shopping cart and confirm/deny checkout. A user may not be allowed to provision a FatToken from a partner application.

For setup, both users and merchants may follow a one-time setup procedure. Users perform the following steps to configure their payment system. First, a user may install an issuer mobile application. Next, the user may authenticate themselves to the issuer mobile application via credentials (e.g., biometrics, knowledge-based check, etc.). The user may enable participation in the present system by clicking on a toggle button. Next, the mobile device SDK sends a request to an issuer backend service to provision FatToken. The mobile device SDK fetches a list of re-encryption keys (<PK_{Issuer→GW1}, PK_{Issuer→GW2}, . . . PK_{Issuer→GWn}>). The mobile device SDK creates FatToken by assembling encrypted user credentials, authentication policies, and re-encryption keys. Next, the mobile device SDK sends FatToken to the authentication mediary system for signing the token. The authentication mediary system signs the FatToken using a secret key and sends the signed FatToken as a response (AMS_Signₛₖ(FT)). The mobile device SDK receives the signed FatToken and stores the signed FatToken locally. Next, the user receives a FatToken-provisioning success message.

A merchant conducts a one-time setup, based on the following steps, to deploy the present system on an e-commerce website of the merchant. First, a merchant selects an appropriate payment gateway and sends a request to the authentication mediary system for a script (e.g., Javascript) library. The authentication mediary system stores a merchant and/or gateway URL in a database and prepares a checkout script library. Next, the merchant downloads the script library to enable the present system for checkouts. The merchant deploys the script library in the e-commerce website. The deployed script library provides both legacy checkout and checkout provided by the presently described system. A similar process may be executed for a POS terminal of a physical storefront.

Once on-boarding and setup procedures are complete, a commerce procedure may be executed in the presently described system. Further details are described below in the context of the drawings.

Systems and Methods

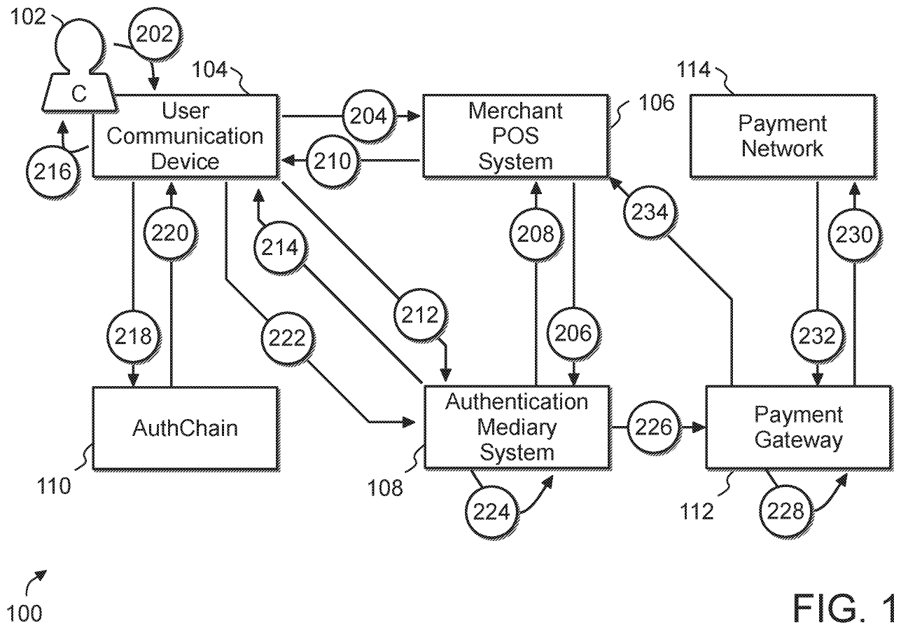

With specific reference to FIG. 1, and in preferred non-limiting embodiments or aspects, provided is a system 100 for secure, remote transaction authentication and settlement. The system 100 includes a customer 102 associated with a user communication device 104, which may be a payment device (e.g., a mobile device). The user communication device 104 may include an audio input device (e.g., microphone) and/or a visual input device (e.g., a camera). The system 100 further includes a merchant POS system 106, which may include a merchant communication device and a merchant POS terminal. The merchant communication device may be the same device as a merchant POS terminal (e.g., a mobile device, a countertop computing device). The POS terminal may include an audio output device (e.g., speaker) and/or a visual output device (e.g., display). The system 100 further includes an authentication mediary system 108, e.g., one or more servers for provisioning and validating token keys, at least in part. The user communication device 104 may be operating a mobile application using a software development kit (SDK) of an authentication mediary system 108. The system 100 further includes AuthChain 110, e.g., a blockchain-based system where any node can perform authentication on behalf of an issuer and log transactions accordingly. The system 100 further includes a payment gateway 112 and a payment network 114, e.g., including a transaction service provider system, an acquirer processor, and/or the like.

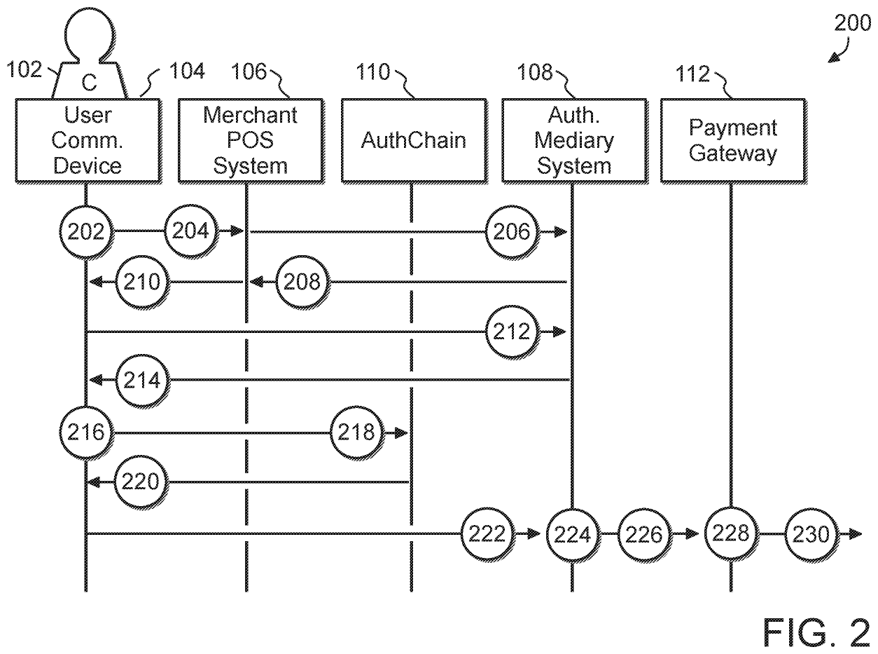

With specific reference to FIGS. 1 and 2, and in preferred non-limiting embodiments or aspects, provided is a system 100 and method 200 for secure, remote transaction authentication and settlement. In step 202, a customer 102 launches an enabled mobile device application and authenticates himself via a form of credentials, e.g., passcode, biometrics (e.g., fingerprint, facial scan, etc.), user name and password, and/or the like. In step 204, the customer 102 may go to a merchant (e.g., physically, electronically) and select items (e.g., goods, services, etc.) for purchase. The customer 102 may be interacting with an online store through which items are added to a virtual shopping cart. The customer 102 may also be interacting with a physical store in which items are collected for purchase. The customer 102 may also scan in-store objects with the user communication device 104 to create a purchase list. Also in step 204, the merchant POS system is provided with the list of one or more items for purchase by the customer 102.

In step 206, the merchant POS system 106 communicates transaction data of the items to be purchased to an authentication mediary system 108. Transaction data may include, but is not limited to, a transaction cost, a transaction description, a transaction time, a merchant identifier, or any combination thereof. In response to receiving the transaction data, the authentication mediary system 108 may communicate a unique identifier representative of the transaction to the merchant POS system 106, in step 208. The authentication mediary system 108 may generate sound data encoding the unique identifier, e.g., an audio QR code, and communicate the sound data to the merchant POS system 106. Alternatively, the merchant POS system 106 may encode the received unique identifier into sound data. In some non-limiting embodiments or aspects, any form of audio or visual signal data may be used to encode the unique identifier, including audio QR code, visual QR code, barcode, and/or the like. The authentication mediary system 108 may store the unique identifier in a database in association with the transaction data.

In step 210, the merchant may present the signal data, e.g., sound data, for detection by the user communication device. In the case of sound data, the POS terminal (e.g., a website, a physical checkout device, etc.) may emit a sound wave (e.g., a musical tone, a voice emulation, an ultra- or infra-sonic tone, etc.) based on the sound data, where the sound wave is a carrier for the embedded/encoded unique identifier (e.g., frequency modulation). In the case of visual signal data, the POS terminal (e.g., a website, a physical checkout device, etc.) may display a visual pattern or code (e.g., a visual QR code, a barcode, alphanumeric code, etc.) based on the signal data, where the visual pattern or code is a carrier for the embedded/encoded unique identifier. Further in step 210, the user communication device 104 may detect the signal data, e.g., sound data, and decode the unique identifier. In step 212, the user communication device 104 may communicate the unique identifier to the authentication mediary system 108.

In step 214, the authentication mediary system 108 may compare the received unique identifier to stored unique identifiers and retrieve stored transaction data associated with the received unique identifier. Further in step 214, the authentication mediary system 108 may communicate at least a portion of the transaction data to the user communication device 102. In step 216, the customer 102 may then review the transaction data and confirm that the items they intended to purchase are reflected in transaction data. The customer 102 may input a confirmation to the user communication device 104. In step 218, the user communication device 104 may retrieve FatToken and other metadata (e.g., device attributes, behavioral attributes, etc.) and communicate the aforesaid to AuthChain 110. AuthChain 110 may receive FatToken and other metadata, execute authentication policies, log the computation, and re-encrypt FatToken against the public key of the payment gateway 112. The user communication device 104 may receive the re-encrypted FatToken from AuthChain 110 in step 220.

In step 222, the user communication device 104 may communicate the re-encrypted FatToken and proof of authentication to the authentication mediary system 108. In step 224, the authentication mediary system 108 may verify the proof of authentication. In step 226, the authentication mediary system 108 may communicate the re-encrypted FatToken to the payment gateway 112 with transaction data. In step 228, the payment gateway 112 may decrypt the FatToken using the private key of the payment gateway 112. Based on the FatToken and transaction data, the payment gateway 112 may send a transaction request to the payment network 114 for authorization in step 230. In step 232, the payment network 114 may authorize or decline the transaction request, and the payment gateway 112 may receive a communication of the authorization or decline. In step 234, the payment gateway 112 may communication a message to the merchant POS system 106 reporting the authorization or the decline.

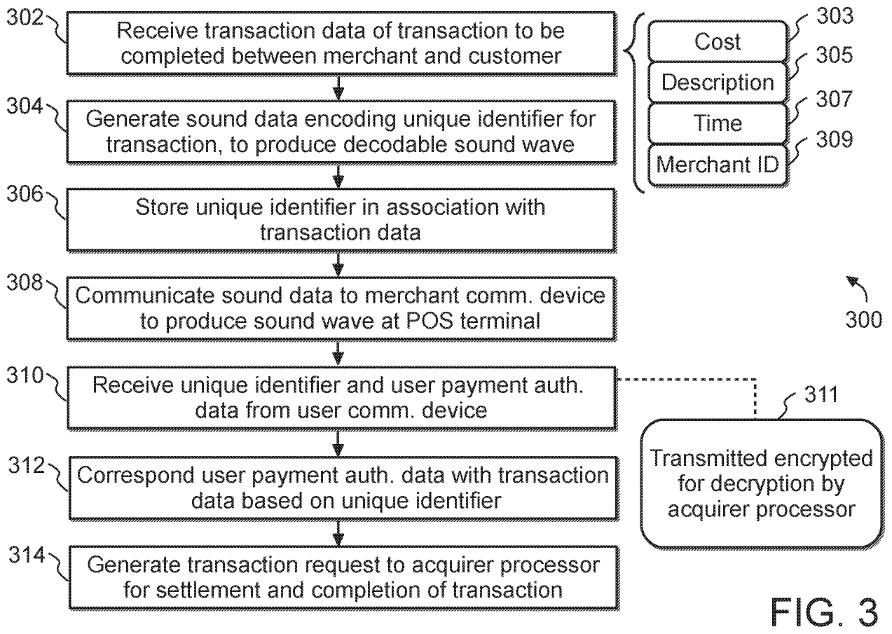

With specific reference to FIG. 3, and in preferred non-limiting embodiments or aspects, provided is a method 300 for secure, remote transaction authentication and settlement. The method 300 may be carried out by one or more computing devices, including those of the authentication mediary system, merchant POS system, payment gateway, another computing device, or a combination thereof. In step 302, the authentication mediary system receives, from a merchant device, transaction data associated with a transaction to be completed between a merchant and a customer via a merchant POS system, including a POS terminal. The transaction data may include, but is not limited to, a transaction cost 303, a transaction description 305, a transaction time 307, a merchant identifier 309, or any combination thereof. In step 304, the authentication mediary system may generate a unique identifier and sound data encoding the unique identifier. The sound data may be configured to cause an audio output device (e.g., speaker) to produce a sound wave such that, when the sound wave is received by an audio input device (e.g., microphone), the sound wave is decodable to provide the unique identifier.

In step 306, the authentication mediary system may store the unique identifier in one or more databases in association with the transaction data. In step 308, the authentication mediary system may communicate the sound data to the merchant communication device (e.g., associated with a merchant POS system) to cause the sound wave to be produced at the POS terminal for receipt and decoding by a user communication device of the customer. Alternatively, the unique identifier may be communicated to the merchant POS system for generation of sound data by the merchant POS system. For a POS terminal that includes a customer-facing online store, the sound wave may be produced on a user device accessing the online store. For a POS terminal of a physical merchant store, the sound wave may be produced on an audio output device of the POS terminal. After the user communication device decodes the unique identifier from the sound wave, the authentication mediary system may receive, in step 310, the unique identifier from the user communication device. In a same or separate communication, in step 310, the authentication mediary system may receive user payment authorization data (e.g., including an account identifier associated with a customer transaction account).

In step 312, the authentication mediary system may correspond, based on the unique identifier received from the user communication device, the user payment authorization data with the transaction data. The user payment authorization data may be encrypted as received from the user communication device, in step 311, and be configured for decryption by a payment gateway and/or acquirer processor. The user payment authorization data may be formatted and encrypted according to a predetermined ruleset input by the payment gateway and/or acquirer processor (e.g., via a portal having an application programming interface). In step 314, the authentication mediary system may generate, or cause a payment gateway to generate, a transaction request to an acquirer processor associated with a merchant transaction account. The transaction request may include the user payment authorization data and the transaction data for settlement of payment from the customer transaction account to the merchant transaction account for completion of the transaction.

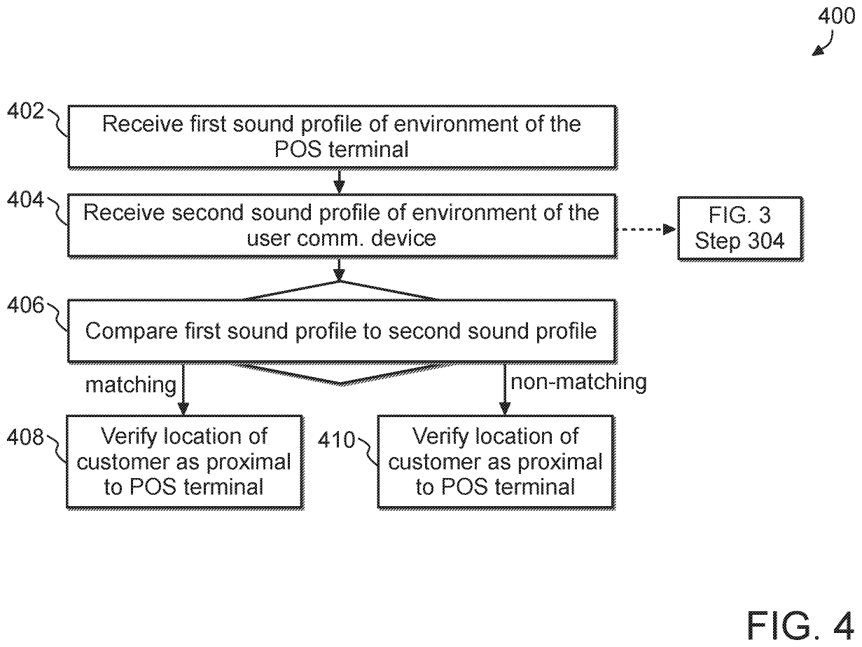

With specific reference to FIG. 4, and in some non-limiting embodiments or aspects, provided is a method 400 for secure, remote transaction authentication and settlement. As with the foregoing method, method 400 may be carried out by one or more computing devices, including those of the authentication mediary system, merchant POS system, payment gateway, another computing device, or a combination thereof. In step 402, the authentication mediary system may receive, from the merchant communication device, a first sound profile (e.g., an audio recording) of an environment of the POS terminal (e.g., a physical merchant store, a space near a computing device hosting an online store website, etc.). In step 404, the authentication mediary system may receive, from the user communication device, a second sound profile (e.g., an audio recording) of an environment of the user communication device (e.g., a physical merchant store, a space near a computing device hosting an online store website, etc.). In step 406, the authentication mediary system may compare the first sound profile to the second sound profile and determine if the sound profiles match (e.g., determine a likelihood of match, determine a percent match, etc.). In doing so, it may be determined if the user communication device (presumed to be near the customer) is in the same environment as the POS terminal.

If the first sound profile and the second sound profile are determined to be matching, or sufficiently matching, in step 406, then the authentication mediary system may verify that the location of the customer is proximal to the POS terminal, in step 408. If the first sound profile and the second sound profile are determined to not match, or not to sufficiently match, in step 406, then the authentication mediary system may reject a verification that the location of the customer is proximal to the POS terminal, in step 410. It will further be appreciated that based on a second sound profile received in step 404, the authentication mediary system may determine a frequency range of the sound wave (during generation of the sound data in step 304 of FIG. 3) that is non-overlapping with a frequency range of a portion of the second sound profile associated with the environment of the user communication device, so as to increase the likelihood and accuracy of the user communication device detecting the sound wave in the environment of the user communication device.

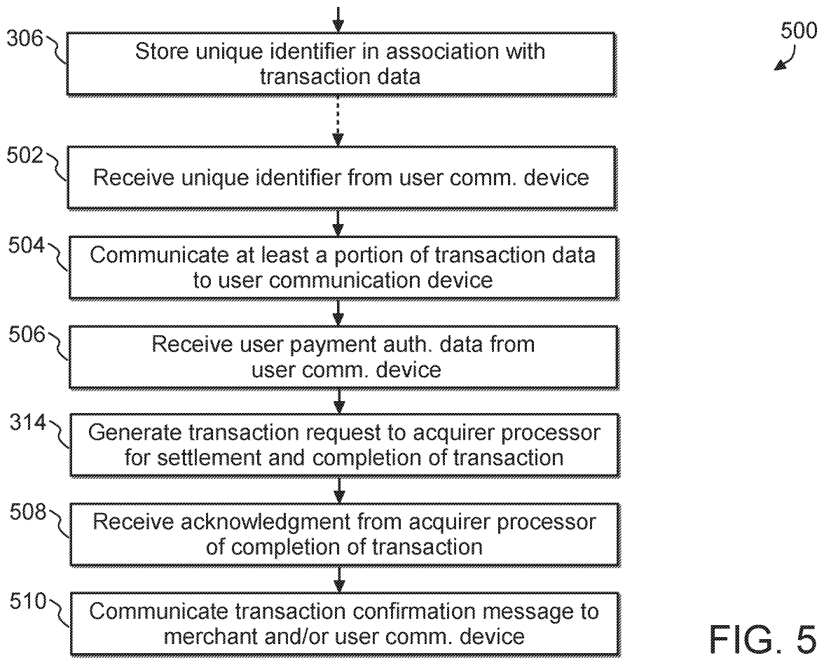

With specific reference to FIG. 5, and in some non-limiting embodiments or aspects, provided is a method 500 for secure, remote transaction authentication and settlement. As with the foregoing methods, method 500 may be carried out by one or more computing devices, including those of the authentication mediary system, merchant POS system, payment gateway, another computing device, or a combination thereof. In step 306, the authentication mediary system may store the unique identifier in association with the transaction data. In step 502, the authentication mediary system may receive the unique identifier from the user communication device, which has received the unique identifier via encoding in a signal (e.g., audio, visual, etc.) from the POS terminal. Before the customer commits to a purchase, the customer may wish to view the list of items of the transaction associated with the unique identifier. Therefore, in step 504, the authentication mediary system may communicate at least a portion of the transaction data to the user communication device prior to receiving the user payment authorization data from the user communication device. The customer may then review the transaction data and confirm or reject the purchase using their user communication device. If the purchase is confirmed and authorized by the customer, then, in step 506, the authentication mediary system may receive user payment authorization data from the user communication device.

In step 314, the authentication mediary system may generate a transaction request, or cause a payment gateway to generate a transaction request, to an acquirer processor associated with a merchant transaction account (or other payment network device), so as to settle payment from the customer transaction account to the merchant transaction account for completion of the transaction. In step 508, the authentication mediary system and/or a payment gateway may receive acknowledgement from an acquirer processor (or other payment network device) of completion of the transaction. In response to step 508, the authentication mediary system and/or the payment gateway may communicate, in step 510, a transaction confirmation message to the merchant communication device and/or the user communication device.

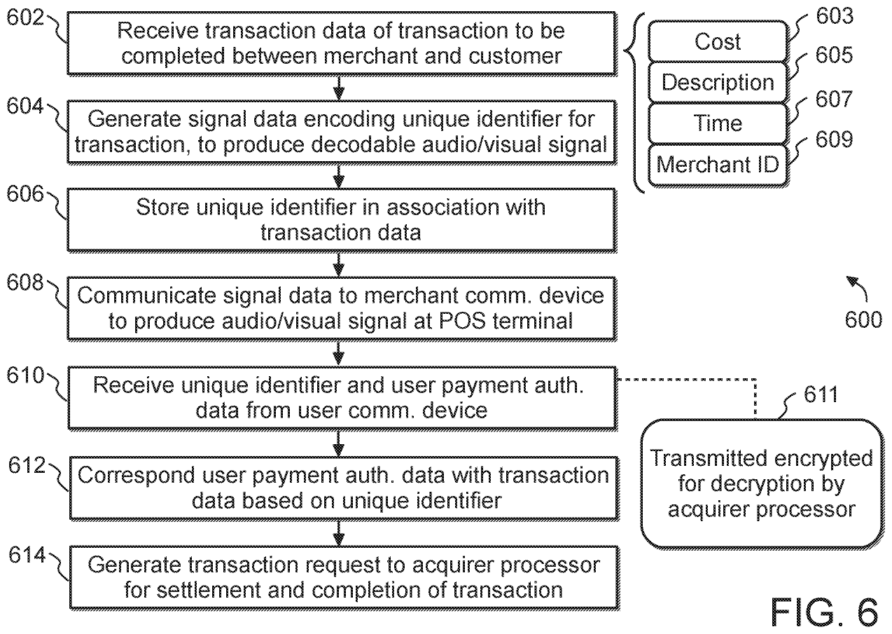

With specific reference to FIG. 6, and in some non-limiting embodiments or aspects, provided is a method 600 for secure, remote transaction authentication and settlement. As with the foregoing methods, method 600 may be carried out by one or more computing devices, including those of the authentication mediary system, merchant POS system, payment gateway, another computing device, or a combination thereof. In step 602, the authentication mediary system may receive, from a merchant communication device, transaction data associated with a transaction to be completed between a merchant and a customer via a POS terminal. The transaction data may include a transaction cost 603, a transaction description 605, a transaction time 607, a merchant identifier 609, or any combination thereof. In step 604, the authentication mediary system may generate a unique identifier for the transaction, and may further generate signal data encoding the unique identifier. The merchant POS system may alternatively generate signal data to encode the unique identifier. The signal data may be configured to cause an audio output device (e.g., speaker) and/or visual output device (e.g., display) to produce an audio signal (e.g., audio QR code) and/or visual signal (e.g., visual QR code), respectively. When the audio signal or visual signal is received by an audio input device (e.g., microphone) and/or visual input device (e.g., camera), the audio signal and/or the visual signal may be decodable to provide the unique identifier.

In step 606, the authentication mediary system may store the unique identifier in association with the transaction data. In step 608, the authentication mediary system may communicate the signal data to the merchant communication device to cause the audio signal and/or the visual signal to be produced at the POS terminal for receipt and decoding by a user communication device of the customer. In step 610, the authentication mediary system may receive, from the user communication device, the unique identifier and user payment authorization data, in a same or separate message. The user payment authorization data may include at least an account identifier associated with a customer transaction account. The user payment authorization data may be transmitted encrypted, in step 611, for decryption by the acquirer processor, payment gateway, or another payment network device. In step 612, the authentication mediary system may correspond the user payment authorization data with the transaction data based on the unique identifier. In step 614, the authentication mediary system may generate, or cause a payment gateway to generate, a transaction request to an acquirer processor associated with a merchant transaction account (or other payment network device). The transaction request may include the user payment authorization data and the transaction data, for settlement of payment from the customer transaction account to the merchant transaction account for completion of the transaction.

Although non-limiting embodiments have been described in detail for the purpose of illustration based on what is currently considered to be the most practical and preferred and non-limiting embodiments, it is to be understood that such detail is solely for that purpose and that the disclosure is not limited to the disclosed embodiments but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A computer-implemented method for secure, remote transaction authentication and settlement, the method comprising:
receiving, with at least one processor from a merchant communication device, transaction data associated with a transaction to be completed between a merchant and a customer via a point-of-sale (POS) terminal, the transaction data comprising at least one of the following: a transaction cost; a transaction description; a transaction time; a merchant identifier; or any combination thereof;
generating, with at least one processor, (i) a unique identifier for the transaction and (ii) sound data encoding the unique identifier, the sound data configured to cause an audio output device to produce a sound wave such that, when the sound wave is received by an audio input device, the sound wave is decodable to provide the unique identifier;
storing, with at least one processor in at least one database, the unique identifier in association with the transaction data;
communicating, with at least one processor, the sound data to the merchant communication device to cause the sound wave to be produced at the POS terminal for receipt and decoding by a user communication device of the customer;
receiving, with at least one processor from the user communication device, the unique identifier and user payment authorization data comprising at least an account identifier associated with a customer transaction account;
corresponding, with at least one processor and based on the unique identifier received from the user communication device, the user payment authorization data with the transaction data; and
generating, with at least one processor, a transaction request to an acquirer processor associated with a merchant transaction account, the transaction request comprising the user payment authorization data and the transaction data for settlement of payment from the customer transaction account to the merchant transaction account for completion of the transaction.

2. The computer-implemented method of claim 1, wherein the user payment authorization data is encrypted as received from the user communication device and is configured for decryption by the acquirer processor.

3. The computer-implemented method of claim 2, wherein the user payment authorization data is formatted and encrypted according to a predetermined ruleset input by the acquirer processor.

4. The computer-implemented method of claim 1, further comprising:
receiving, with at least one processor from the merchant communication device, a first sound profile of an environment of the POS terminal;
receiving, with at least one processor from the user communication device, a second sound profile of an environment of the user communication device, the second sound profile recorded during receipt of the sound wave by the user communication device from the POS terminal; and
verifying, with at least one processor, a location of the customer as proximal to the POS terminal based on a comparison of the first sound profile to the second sound profile.

5. The computer-implemented method of claim 4, wherein a frequency range of the sound wave is non-overlapping with a frequency range of a portion of the second sound profile associated with the environment of the user communication device.

6. The computer-implemented method of claim 1, further comprising, in response to receiving the unique identifier from the user communication device, communicating, with at least one processor, at least a portion of the transaction data to the user communication device prior to receiving the user payment authorization data from the user communication device.

7. The computer-implemented method of claim 1, further comprising, in response to receiving an acknowledgment from the acquirer processor of the transaction being completed pursuant to the transaction request, communicating, with at least one processor, a transaction confirmation message to the merchant communication device and/or the user communication device.

8. A system for secure, remote transaction authentication and settlement, the system comprising at least one server computer including at least one processor, the at least one server computer programmed and/or configured to:
receive, from a merchant communication device, transaction data associated with a transaction to be completed between a merchant and a customer via a point-of-sale (POS) terminal, the transaction data comprising at least one of the following: a transaction cost; a transaction description; a transaction time; a merchant identifier; or any combination thereof;
generate (i) a unique identifier for the transaction and (ii) sound data encoding the unique identifier, the sound data configured to cause an audio output device to produce a sound wave such that, when the sound wave is received by an audio input device, the sound wave is decodable to provide the unique identifier;
store, in at least one database, the unique identifier in association with the transaction data;
communicate the sound data to the merchant communication device to cause the sound wave to be produced at the POS terminal for receipt and decoding by a user communication device of the customer;
receive, from the user communication device, the unique identifier and user payment authorization data comprising at least an account identifier associated with a customer transaction account;
correspond, based on the unique identifier received from the user communication device, the user payment authorization data with the transaction data; and
generate a transaction request to an acquirer processor associated with a merchant transaction account, the transaction request comprising the user payment authorization data and the transaction data for settlement of payment from the customer transaction account to the merchant transaction account for completion of the transaction.

9. The system of claim 8, wherein the user payment authorization data is encrypted as received from the user communication device and is configured for decryption by the acquirer processor.

10. The system of claim 9, wherein the user payment authorization data is formatted and encrypted according to a predetermined ruleset input by the acquirer processor.

11. The system of claim 8, wherein the at least one server computer is further programmed and/or configured to:
receive, from the user communication device, a second sound profile of an environment of the user communication device, the second sound profile recorded during receipt of the sound wave by the user communication device from the POS terminal; and
verify a location of the customer as proximal to the POS terminal based on a comparison of the first sound profile to the second sound profile.

12. The system of claim 11, wherein a frequency range of the sound wave is non-overlapping with a frequency range of a portion of the second sound profile associated with the environment of the user communication device.

13. The system of claim 8, wherein the at least one server computer is further programmed and/or configured to, in response to receiving the unique identifier from the user communication device, communicate at least a portion of the transaction data to the user communication device prior to receiving the user payment authorization data from the user communication device.

14. The system of claim 8, wherein the at least one server computer is further programmed and/or configured to, in response to receiving an acknowledgment from the acquirer processor of the transaction being completed pursuant to the transaction request, communicate a transaction confirmation message to the merchant communication device and/or the user communication device.

15. A computer program product for secure, remote transaction authentication and settlement, the computer program product comprising at least one non-transitory computer-readable medium including program instructions that, when executed by at least one processor, cause the at least one processor to:
receive, from a merchant communication device, transaction data associated with a transaction to be completed between a merchant and a customer via a point-of-sale (POS) terminal, the transaction data comprising at least one of the following:
a transaction cost; a transaction description; a transaction time; a merchant identifier; or any combination thereof;
generate (i) a unique identifier for the transaction and (ii) sound data encoding the unique identifier, the sound data configured to cause an audio output device to produce a sound wave such that, when the sound wave is received by an audio input device, the sound wave is decodable to provide the unique identifier;
store, in at least one database, the unique identifier in association with the transaction data;
communicate the sound data to the merchant communication device to cause the sound wave to be produced at the POS terminal for receipt and decoding by a user communication device of the customer;
receive, from the user communication device, the unique identifier and user payment authorization data comprising at least an account identifier associated with a customer transaction account;
correspond, based on the unique identifier received from the user communication device, the user payment authorization data with the transaction data; and
generate a transaction request to an acquirer processor associated with a merchant transaction account, the transaction request comprising the user payment authorization data and the transaction data for settlement of payment from the customer transaction account to the merchant transaction account for completion of the transaction.

16. The computer program product of claim 15, wherein the user payment authorization data is encrypted as received from the user communication device and is configured for decryption by the acquirer processor.

17. The computer program product of claim 16, wherein the user payment authorization data is formatted and encrypted according to a predetermined ruleset input by the acquirer processor.

18. The computer program product of claim 15, wherein the program instructions further cause the at least one processor to:
receive, from the user communication device, a second sound profile of an environment of the user communication device, the second sound profile recorded during receipt of the sound wave by the user communication device from the POS terminal; and
verify a location of the customer as proximal to the POS terminal based on a comparison of the first sound profile to the second sound profile.

19. The computer program product of claim 18, wherein a frequency range of the sound wave is non-overlapping with a frequency range of a portion of the second sound profile associated with the environment of the user communication device.

20. The computer program product of claim 15, wherein the program instructions further cause the at least one processor to, in response to receiving the unique identifier from the user communication device, communicate at least a portion of the transaction data to the user communication device prior to receiving the user payment authorization data from the user communication device.

21.-22. (canceled)
